(19) United States
(12) Patent Application Publication
(10) Pub. No.: US 2017/0266678 A1
(43) Pub. Date: Sep. 21, 2017

(54) SPRAY BOTTLE WITH STORAGE

(71) Applicant: FREDRICK HARRINGTON, Rex, GA (US)

(72) Inventor: FREDRICK HARRINGTON, Rex, GA (US)

(21) Appl. No.: 15/454,523

(22) Filed: Mar. 9, 2017

Related U.S. Application Data
(60) Provisional application No. 62/308,524, filed on Mar. 15, 2016.

(51) Int. Cl. B05B 11/00; B05B 15/00; B65D 41/04; B65D 51/24; B65D 21/02; B05B 12/00; B05B 15/06

(52) U.S. Cl. CPC B05B 11/0035; B05B 12/002; B05B 15/005; B05B 15/061; B65D 51/242; B65D 21/0228; B65D 41/04

(57) ABSTRACT

An all-in-one spray bottle with attached storage unit is disclosed, which is particularly useful for dispensing cleaning fluid for use with a cleansing cloth that is held in the attached storage unit.

### CROSS-REFERENCE TO RELATED APPLICATIONS

This application claims the benefit of U.S. Application No. 62/308,524 filed Mar. 15, 2016, which is incorporated herein in its entirety.

### FIELD OF THE INVENTION

The invention relates generally to an all-in-one spray bottle with attached storage unit, which is particularly useful for dispensing cleaning fluid for use with a cleansing cloth that is held in the attached storage unit.

### BACKGROUND OF THE INVENTION

Eyewear comes in many forms, including prescription eyeglasses, piano sunglasses, over-the-counter reading glasses, safety goggles, sports googles, and like. During use and storage, the eyewear becomes dirty with fingerprints, oil, and other grime, which impairs the view through the eyewear. People use a variety of different materials and techniques to clean the eyewear. Examples include blow cleaners, cleansing cloths, cotton pads, paper towels, clothing, and facial tissue. However, some of these materials and techniques cause damage, such as scratches and crazing, to the lenses themselves or the coatings on the lenses or leave a residue on the eyewear.

What is needed is a device for cleaning eyewear is safe and appropriate for the task but also convenient for the user. The invention is directed to these, as well as other, important needs.

### SUMMARY OF THE INVENTION

The invention provides a device that enables a person to conveniently carry cleaning fluid and cleansing cloth, especially for eyeglasses but also hard surfaces, including glass, mirror, and the surfaces of electronic equipment (such as cell phones, tablets, computers, and related equipment). The device is small enough to be attached to a keychain and/or be carried in a pocket or bag (such as a handbag, diaper bag, or backpack).

Accordingly, in one embodiment, the invention is directed to devices comprising:
a canister (1) having a first end (13) and a second end (14), said canister comprising:
   a fluid compartment (11) for holding a cleaning fluid;
   a storage cavity (10) for holding a cleansing cloth (9);
   a first base (5) attached to said first end (13); and
   a second base (8) attached to said second end (14);
a spray assembly (15);
a spray nozzle cap (2) detachably connected to said first base (5); and
a storage cavity cap (3) detachably connected to said second base (8).

In another embodiment, the invention is directed to devices comprising:
a canister (1) having a first end (13) and a second end (14), said canister comprising:
   a cleaning fluid;
   a cleansing cloth (9);
   a fluid compartment (11) for holding said cleaning fluid;
   a storage cavity (10) for holding a cleansing cloth (9);
   a first base (5) attached to said first end (13);
      wherein said first base (5) is threaded;
   a second base (8) attached to said second end (14);
      wherein said a second base (8) is threaded;
a spray assembly (15);
   wherein said spray assembly comprises:
      a spray nozzle (6);
      an orifice (7); and
      a siphon tube (12);
a spray nozzle cap (2) detachably connected to said first base (5);
   wherein said spray nozzle cap comprises a key ring (4); and

a storage cavity cap (3) detachably connected to said second base (8).

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A is an elevation view of one embodiment of the device of the invention.

FIG. 1B is an exploded elevation view of the embodiment shown in FIG. 1A with the spray nozzle cap, storage cap, cleansing cloth, and stabilizing pole for the cleansing cloth removed from the remainder of the device.

FIG. 1C is a bottom view of the embodiment shown in FIG. 1B shown without the cleansing cloth, stabilizing pole for the cleansing cloth, and storage cap.

FIG. 1D is a cross-sectional view of the embodiment shown in FIG. 1B shown through line A-A.

### DETAILED DESCRIPTION OF THE INVENTION

The following definitions are provided for the full understanding of terms used in this specification. As used herein, the article “a” means “at least one,” unless the context in which the article is used clearly indicates otherwise.

Reference will now be made in detail to the preferred embodiments of the invention, examples of which are illustrated in the drawings and the examples. This invention may, however, be embodied in many different forms and should not be construed as limited to the embodiments set forth herein. In addition and as will be appreciated by one of skill in the art, the invention may be embodied as a product, method, system or process.

The invention provides a device that enables a person to conveniently carry cleaning fluid and cleansing cloth, especially for eyeglasses but also hard surfaces, including glass, mirror, and the surfaces of electronic equipment (such as cell phones, tablets, computers, and related equipment). The device is small enough to be attached to a keychain and/or be carried in a pocket or bag (such as a handbag, diaper bag, or backpack).

Accordingly, in one embodiment, the invention is directed to devices comprising:
a canister (1) having a first end (13) and a second end (14), said canister comprising:
   a fluid compartment (11) for holding a cleaning fluid;
   a storage cavity (10) for holding a cleansing cloth (9);
   a first base (5) attached to said first end (13); and
   a second base (8) attached to said second end (14);
a spray assembly (15);
a spray nozzle cap (2) detachably connected to said first base (5); and
a storage cavity cap (3) detachably connected to said second base (8).

In another embodiment, the invention is directed to devices comprising:
a canister (1) having a first end (13) and a second end (14), said canister comprising:
   a cleaning fluid;
   a cleansing cloth (9);
   a fluid compartment (11) for holding said cleaning fluid;
   a storage cavity (10) for holding a cleansing cloth (9);
   a first base (5) attached to said first end (13);
      wherein said first base (5) is threaded;
   a second base (8) attached to said second end (14);
      wherein said a second base (8) is threaded;
a spray assembly (15);
   wherein said spray assembly comprises:
      a spray nozzle (6);
      an orifice (7); and
      a siphon tube (12);
a spray nozzle cap (2) detachably connected to said first base (5);
   wherein said spray nozzle cap comprises a key ring (4); and
a storage cavity cap (3) detachably connected to said second base (8).

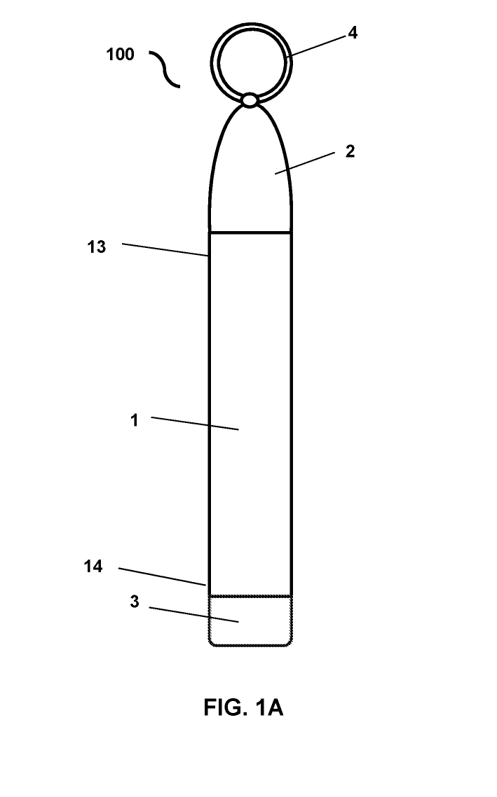

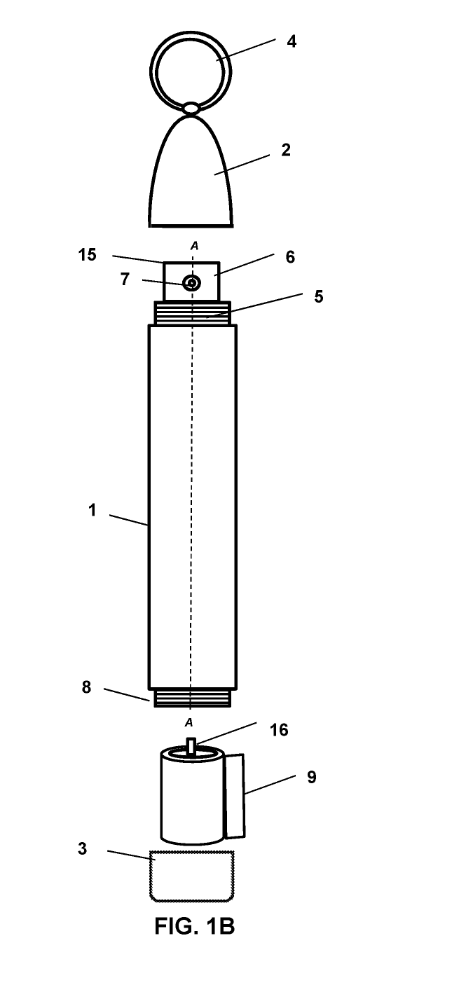

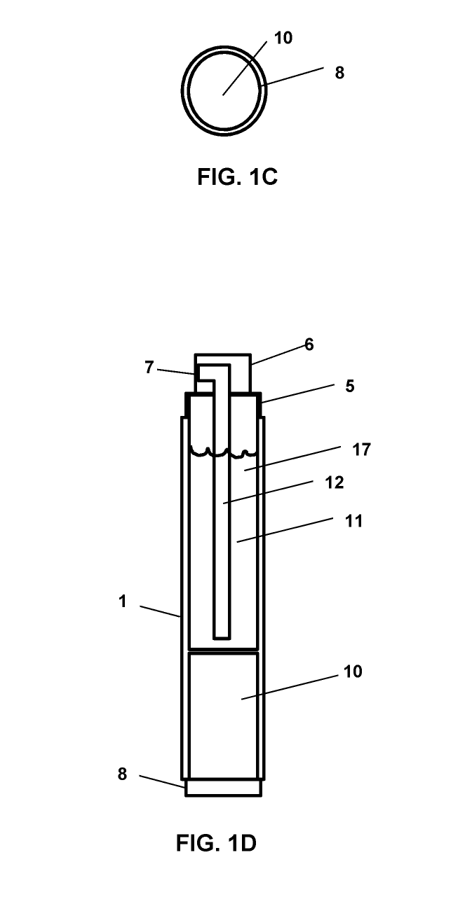

With reference to specific embodiments, FIG. 1A is an elevation view of one embodiment of the device (100) of the invention. FIG. 1B is an exploded elevation view of the embodiment shown in FIG. 1A with the spray nozzle cap (2), storage cap (3), cleansing cloth (9), and stabilizing pole for the cleansing cloth (16) removed from the remainder of the device. FIG. 1C is a bottom view of the embodiment shown in FIG. 1B shown without the cleansing cloth (9), stabilizing pole for the cleansing cloth (16) and storage cap (3) removed from the storage cavity (10). FIG. 1D is a cross-sectional view of the embodiment shown in FIG. 1B shown through line A-A that shows the cleaning fluid (17) in the fluid compartment (11). The figures are shown with a key ring (4). However, other attachment mechanisms are possible.

Canister (1) has a first end (13) and a second end (14). As can be seen in the exploded view of FIG. 1B, the canister contains a fluid compartment (11) for holding a cleaning fluid (not shown) and a storage cavity (10) for holding a cleansing cloth (9) with stabilizing pole (16). The canister may be any suitable shape, but is preferably substantially circular in cross section. A first base (5) is attached to said first end (13) and a second base (8) attached to said second end (14). The device also includes a spray assembly (15), which may contain a spray nozzle (6); an orifice (7); and a siphon tube (12), as shown in FIG. 1D. A spray nozzle cap (2) is detachably connected to said first base (5). A storage cavity cap (3) is detachably connected to said second base (8). In operation, the user removes the storage cavity cap (3) to access the cleansing cloth (9), which preferably rolled around stabilizing pole (16). The user also removes the spray nozzle cap to access the spray assembly (15) for spraying cleaning fluid onto the surface which is to cleaned and wiped with the cleansing cloth (9). When the cleaning is completed, the user rolls the cleansing cloth (9) around the stabilizing pole (16) and reinserts the rolled cleansing cloth (9) and stabilizing pole (16) in the storage cavity and reinstalls the storage cavity cap (3) onto the second base (8). The user reinstalls the spray nozzle cap onto the first base (5).

The device may be made from any suitable material. The choice of materials may be driven by whether the particular device is intended to be disposable or refillable. Lightweight polymeric materials are preferred for all applications but particularly for disposable devices. The material is selected to be resistant to the cleaning fluid contained in the device. Suitable materials include, but are not limited to, polyethylene, polypropylene, nylon, and the like, and combinations thereof.

The cleaning fluid may be any suitable cleaning fluid for the particular application (for eyewear or hard surface). For example, the cleaning fluid may contain ammonia. In other applications, the cleaning fluid may be ammonia free. In yet other applications, especially for handheld device, the cleaning fluid may be an antimicrobial fluid.

The cleaning fluid may be any suitable cleaning material for the particular application (for eyewear or hard surface). For example, the cleansing cloth may be a microfiber cloth. In certain applications, the cleansing cloth may be antistatic.

In certain embodiments, the spray nozzle cap comprises an attachment mechanism, such as, for example, a key ring, a detachable lanyard, a hook, a hook and loop fastener, a ball chain, a ball and plate chain, a braided wire fastener, or a combination thereof. Suitable hooks include, for example, a snap hook, an S hook, a swivel hook, a spring hook, a trigger snap hook, or a bolt snap hook. In certain embodiments, the key ring is replaced with a snap hook or equivalent device, which enable the user to attach the device to an outer garment, belt loop, gym bag, hand bag, diaper bag, backpack or the like.

In certain embodiments, the first base (5) may be threaded to hold a threadable cap or the spray nozzle cap may be a snap-on cap. In certain embodiments, the second base (8) may be threaded to a hold a threadable cap or the storage cap may be a snap-on cap.

In certain embodiments, the capacity of the canister is at least 5 ml, but preferably no greater 25 ml, especially for application where the device will be attached via a key ring.

It will be apparent to those skilled in the art that various modifications and variations can be made in the present invention and specific examples provided herein without departing from the spirit or scope of the invention. Thus, it is intended that the present invention cover the modifications and variations of this invention that come within the scope of any claims and their equivalents.

When ranges are used herein for physical properties, such as molecular weight, or chemical properties, such as chemical formulae, all combinations, and subcombinations of ranges specific embodiments therein are intended to be included.

The disclosures of each patent, patent application and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

| Component Number | Component Name |
|---|---|
| 1 | Canister |
| 2 | Spray nozzle cap |
| 3 | Storage cap |
| 4 | Key ring |
| 5 | Threaded cap base for spray nozzle cap (first base) |
| 6 | Spray nozzle |
| 7 | Orifice of spray nozzle |
| 8 | Threaded cap base for storage cap (second base) |
| 9 | Cleansing cloth |
| 10 | Storage cavity |
| 11 | Fluid compartment |
| 12 | Siphon tube |
| 13 | First end of the canister |
| 14 | Second end of the canister |
| 15 | Spray assembly |
| 16 | Stabilizing pole for cleansing cloth |
| 17 | Cleaning fluid |
| 100 | Device |

What is claimed is:

1. A device, comprising:
a canister (1) having a first end (13) and a second end (14), said canister comprising:
a fluid compartment (11) for holding a cleaning fluid;
a storage cavity (10) for holding a cleansing cloth (9);
a first base (5) attached to said first end (13); and
a second base (8) attached to said second end (14);
a spray assembly (15);
a spray nozzle cap (2) detachably connected to said first base (5); and
a storage cavity cap (3) detachably connected to said second base (8).

2. The device of claim 1, further comprises:
a cleaning fluid.

3. The device of claim 2,
wherein said cleaning fluid is ammonia.

4. The device of claim 2,
wherein said cleaning fluid is an ammonia-free fluid.

5. The device of claim 2,
wherein said cleaning fluid is an antimicrobial fluid.

6. The device of claim 1, further comprises:
a cleansing cloth.

7. The device of claim 1,
wherein said cleansing cloth is a microfiber cloth.

8. The device of claim 1,
wherein said cleansing cloth is an antistatic cloth.

9. The device of claim 6, further comprising:
a stabilizing pole for said cleansing cloth.

10. The device of claim 1,
wherein said spray nozzle cap comprises an attachment mechanism.

11. The device of claim 10,
wherein said spray nozzle cap comprises an attachment mechanism selected from the group consisting of a key ring, a detachable lanyard, a hook, a hook and loop fastener, a ball chain, a ball and plate chain, a braided wire fastener, or a combination thereof.

12. The device of claim 11,
wherein said hook is a snap hook, an S hook, a swivel hook, a spring hook, a trigger snap hook, or a bolt snap hook.

13. The device of claim 1,
wherein said first base (5) is threaded.

14. The device of claim 1,
wherein said a second base (8) is threaded.

15. The device of claim 1,
wherein said spray nozzle cap is a snap-on cap.

16. The device of claim 1,
wherein said storage cavity cap is a snap-on cap.

17. The device of claim 1,
wherein said spray assembly comprises:
a spray nozzle (6);
an orifice (7); and
a siphon tube (12).

18. The device of claim 1,
wherein the capacity of said canister is at least 5 ml.

19. The device of claim 1,
wherein said device is disposable.

20. A device, comprising:
a canister (1) having a first end (13) and a second end (14), said canister comprising:
a cleaning fluid (17);
a cleansing cloth (9);
a stabilizing pole for said cleansing cloth (16);
a fluid compartment (11) for holding said cleaning fluid;
a storage cavity (10) for holding a cleansing cloth (9);
a first base (5) attached to said first end (13);
wherein said first base (5) is threaded;
a second base (8) attached to said second end (14);
wherein said a second base (8) is threaded;
a spray assembly (15);
wherein said spray assembly comprises:
a spray nozzle (6);
an orifice (7); and
a siphon tube (12);
a spray nozzle cap (2) detachably connected to said first base (5);
wherein said spray nozzle cap comprises a key ring (4); and
a storage cavity cap (3) detachably connected to said second base (8).
